(19) United States
(12) Patent Application Publication
(10) Pub. No.: US 2021/0060932 A1
(43) Pub. Date: Mar. 4, 2021

(54) IMAGE FORMING APPARATUS AND IMAGE FORMING METHOD

(71) Applicant: Konica Minolta, Inc., Tokyo (JP)

(72) Inventor: Sho KARAKAMA, Kanagawa (JP)

(21) Appl. No.: 16/997,889

(22) Filed: Aug. 19, 2020

(30) Foreign Application Priority Data
Aug. 29, 2019 (JP) 2019-156775

(51) Int. Cl. B41J 2/045

(52) U.S. Cl. CPC B41J 2/04556; B41J 2/04586

(57) ABSTRACT

An image forming apparatus includes: a first image former that forms a first image in an image forming region of a recording medium; and a second image former that forms a second image in a margin region to cause a height difference between the image forming region where the first image is formed and the margin region to be reduced.

The entire disclosure of Japanese patent Application No. 2019-156775, filed on Aug. 29, 2019, is incorporated herein by reference in its entirety.

### BACKGROUND

### Technological Field

The present invention relates to an image forming apparatus and an image forming method.

### Description of the Related Art

There is conventionally an inkjet image forming apparatus that forms an image on a recording medium conveyed by a conveying device by ejecting ink from a plurality of nozzles provided in an image forming head and fixing the ink. As the ink (coloring material) used for forming an image, for example, one having ultraviolet curability is used, which is cured by being irradiated with ultraviolet rays.

As a technology related to the inkjet image forming apparatus, an inkjet recording apparatus has been disclosed in which there is no possibility that a recording medium is contaminated by discarded ink when printing is performed on the start edge, the end edge, or both of the recording medium with no margin, and further a position during printing of the recording medium is firmly regulated and printing quality of the recording medium is not degraded (for example, see JP 2007-38691 A).

Furthermore, an image forming apparatus is disclosed that is enabled to perform marginless printing without affecting landing position accuracy when a sheet is conveyed by a suction method (for example, see JP 2011-255635 A).

By the way, in the inkjet image forming apparatus described above, as illustrated in FIGS. 1A and 1B (cross-sectional view taken along a line A-A in FIG. 1A), between an image forming region R1 (defined by a dotted line) on a recording medium P and a margin region R2 set outside the image forming region, a minute height difference is generated by the height of ink I fixed to the image forming region R1. That is, the upper surface of the image forming region R1 is higher than the upper surface of the margin region R2 by the height of the ink I.

For that reason, as illustrated in FIG. 1C, when a plurality of the recording media P in which a minute height difference is generated is sequentially stacked one on top of the other on a sheet ejection tray 31, the height differences are accumulated, and the margin region R2 (end side) lower in height than the image forming region R1 hangs down.

As a result, there has been a problem that, for example, when the recording media P are stacked one by one on the sheet ejection tray 31 by freely falling while being abutted against a sheet abutting guide 110, slipping or stack collapsing may occur among the recording media P stacked.

Note that, the technologies disclosed in JP 2007-38691A and JP 2011-255635A do not aim at suppressing the occurrence of slipping or stack collapsing among recording media stacked, and cannot solve the above problem.

### SUMMARY

An object of the present invention is to provide an image forming apparatus and an image forming method capable of suppressing the occurrence of slipping or stack collapsing among recording media stacked.

To achieve the abovementioned object, according to an aspect of the present invention, an image forming apparatus reflecting one aspect of the present invention comprises: a first image former that forms a first image in an image forming region of a recording medium; and a second image former that forms a second image in a margin region to cause a height difference between the image forming region where the first image is formed and the margin region to be reduced.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIGS. 1A to 1C are diagrams illustrating a problem of a conventional technology;

FIG. 2 is a diagram illustrating a schematic configuration of an inkjet image forming apparatus;

FIG. 3 is a schematic diagram illustrating a configuration of a head unit;

FIG. 4 is a block diagram illustrating a main functional configuration of the inkjet image forming apparatus;

FIGS. 5A to 5C are diagrams explaining a principle of solving the problem of the conventional technology;

FIG. 6 is a flowchart illustrating an example of image forming processing; and

FIGS. 7A to 7D are diagrams each illustrating a modification of a pattern of an image formed in a margin region.

### DETAILED DESCRIPTION OF EMBODIMENTS

Hereinafter, one or more embodiments of the present invention will be described with reference to the drawings. However, the scope of the invention is not limited to the disclosed embodiments.

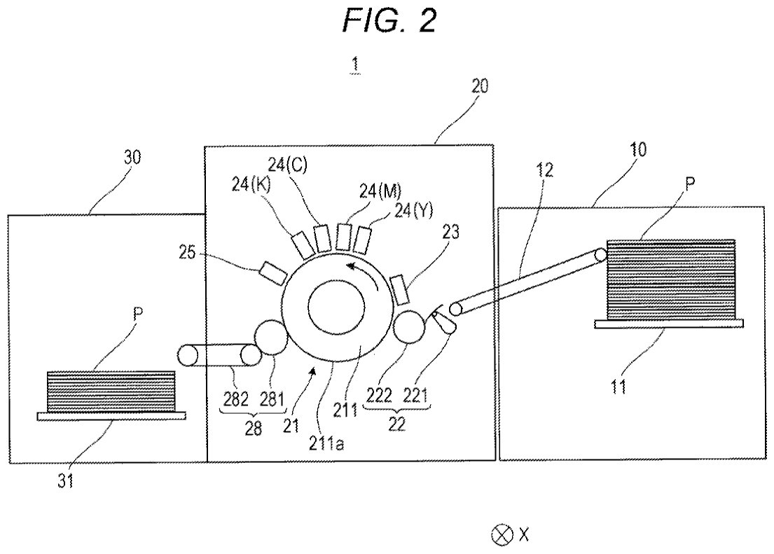

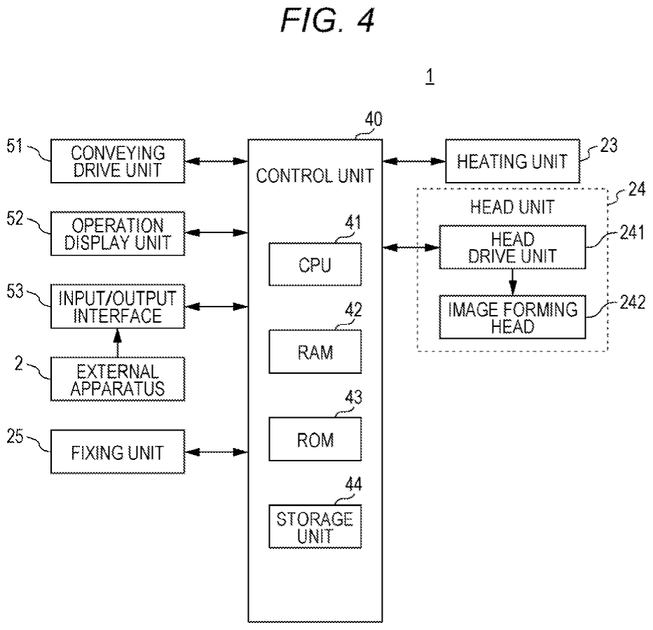

FIG. 2 is a diagram illustrating a schematic configuration of an inkjet image forming apparatus 1. The inkjet image forming apparatus 1 includes a sheet feeding unit 10, an image former 20, a sheet ejection unit 30, and a control unit 40 (see FIG. 4).

In the inkjet image forming apparatus 1 (functions as an “image forming apparatus” of the present invention), under the control of the control unit 40, a recording medium P stored in the sheet feeding unit 10 is conveyed to the image former 20, an image is formed on the recording medium P by the image former 20 (functions as a “first image former” and a “second image former” of the present invention), and the recording medium P on which the image is formed is conveyed to the sheet ejection unit 30. As the recording medium P, in addition to paper such as a plain sheet or a coated sheet, various media can be used on which ink having landed on the surface can be fixed, such as cloth or sheet-like resin.

The sheet feeding unit 10 includes a sheet feeding tray 11 that stores the recording medium P, and a medium supply unit 12 that conveys and supplies the recording medium P from the sheet feeding tray 11 to the image former 20. The medium supply unit 12 includes a ring-shaped belt whose inner side is supported by two rollers, and rotates the rollers while the recording medium P is placed on the belt to convey the recording medium P from the sheet feeding tray 11 to the image former 20.

The image former 20 includes a conveying unit 21, a handover unit 22, a heating unit 23, a head unit 24, a fixing unit 25, a delivery unit 28, and the like.

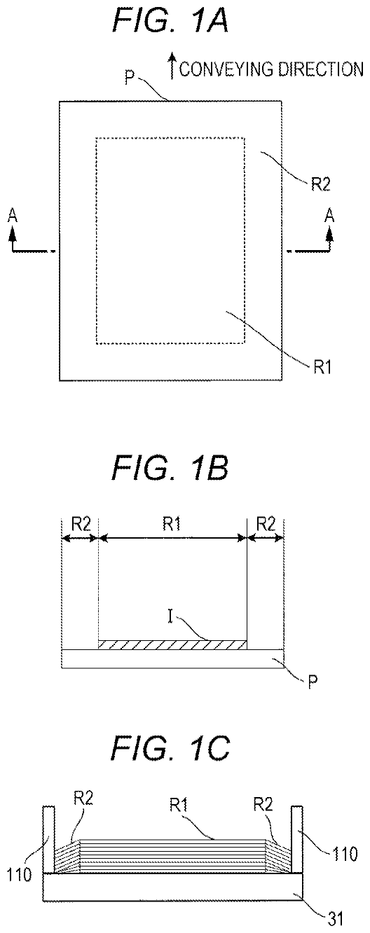

The conveying unit 21 performs conveying operation of holding the recording medium P placed on a conveying surface 211a (placement surface) of a conveying drum 211 having a cylindrical shape, and conveying the recording medium P on the conveying drum 211 in a conveying direction (Y direction) by circumferential movement by causing the conveying drum 211 to rotate around a rotating shaft (cylinder shaft) extending in the X direction (direction perpendicular to the page surface of FIG. 1A to 1C). The conveying drum 211 includes a claw unit and a suction unit (not illustrated) for holding the recording medium P on the conveying surface 211a. The recording medium P is held on the conveying surface 211a by being pressed at the end by the claw unit and by being sucked to the conveying surface 211a by the suction unit. The conveying unit 21 is connected to a conveying drum motor (not illustrated) for rotating the conveying drum 211. The conveying drum 211 rotates by an angle proportional to the amount of rotation of the conveying drum motor.

The handover unit 22 hands over the recording medium P conveyed by the medium supply unit 12 of the sheet feeding unit 10 to the conveying unit 21. The handover unit 22 is provided at a position between the medium supply unit 12 of the sheet feeding unit 10 and the conveying unit 21, and holds one end of the recording medium P conveyed from the medium supply unit 12 with a swing arm unit 221 to pick the recording medium Pup, and then hands over the recording medium P to the conveying unit 21 via the handover drum 222.

The heating unit 23 is provided between the arrangement position of the handover drum 222 and the arrangement position of the head unit 24, and heats the recording medium P so that the recording medium P conveyed by the conveying unit 21 has a temperature within a predetermined temperature range. The heating unit 23 includes, for example, an infrared heater or the like, and energizes the infrared heater on the basis of a control signal supplied from the control unit 40 to cause the infrared heater to generate heat.

The head unit 24 forms an image by ejecting ink onto the recording medium P from a nozzle opening provided on an ink ejection surface facing the conveying surface 211a of the conveying drum 211, at an appropriate timing depending on rotation of the conveying drum 211 by which the recording medium P is held. The head unit 24 is arranged such that the ink ejection surface and the conveying surface 211a are separated from each other by a predetermined distance. In the inkjet image forming apparatus 1 according to the present embodiment, four head units 24 respectively corresponding to four color inks of yellow (Y), magenta (M), cyan (C), and black (K) are arranged to line up at predetermined intervals in the order of Y, M, C, and K colors from the upstream side in the conveying direction of the recording medium P.

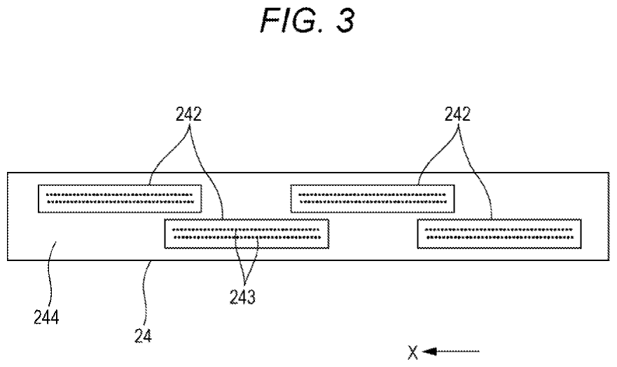

FIG. 3 is a schematic diagram illustrating a configuration of the head unit 24. Here, of the head unit 24, a surface facing the conveying surface 211a of the conveying drum 211 is illustrated.

The head unit 24 includes four image forming heads 242 attached to an attachment member 244. Each of the image forming heads 242 is provided with a plurality of image forming elements (recording elements) each including a pressure chamber that stores ink, a piezoelectric element provided on the wall surface of the pressure chamber, and a nozzle 243. In this image forming element, when a drive signal for causing the piezoelectric element to perform deformation motion is input, the pressure chamber is deformed by the deformation of the piezoelectric element, the pressure inside the pressure chamber changes, and ink is ejected from the nozzle communicating with the pressure chamber.

In the image forming head 242, two nozzle rows are formed each including the nozzles 243 arranged at equal intervals in a direction intersecting the conveying direction of the recording medium P (in the present embodiment, a direction orthogonal to the conveying direction, that is, the X direction). These two nozzle rows are provided such that the arrangement positions of the nozzles 243 are shifted from each other in the X direction by half the arrangement interval of the nozzles 243 in each nozzle row.

The four image forming heads 242 are arranged in a hound's-tooth check pattern so that arrangement ranges of the nozzle row in the X direction are seamlessly connected together. The arrangement range in the X direction of the nozzles 243 included in the head unit 24 covers the width in the X direction of a region where an image is formed in the recording medium P conveyed by the conveying unit 21, and the position of the head unit 24 is fixed and used with respect to the rotating shaft of the conveying drum 211 during image formation. That is, the head unit 24 includes a line head capable of ejecting ink over an image formable width in the X direction with respect to the recording medium P, and the inkjet image forming apparatus 1 is a single-pass type inkjet image forming apparatus.

Note that, the number of nozzle rows included in the image forming head 242 may be one, or three or more, instead of two. Furthermore, the number of the image forming heads 242 included in the head unit 24 may be three or less, or five or more, instead of four.

As the ink (coloring material) ejected from the nozzles of the image forming element, one is used having a property of undergoing a phase change into a gel or sol state depending on temperature, and having a property (ultraviolet curability) of being cured by irradiation with energy rays such as ultraviolet rays (for example, UV curable ink or gel ink). Furthermore, in the present embodiment, an ink is used that is in a gel state at room temperature and is in a sol state when heated. The head unit 24 includes an ink heating unit (not illustrated) that heats the ink stored in the head unit 24. The ink heating unit operates under the control of the control unit 40, and heats the ink to a temperature at which the ink is in a sol state.

The image forming head 242 ejects the ink that is heated and in a sol state. When the ink in a sol state is ejected onto the recording medium P, the ink droplets land on the recording medium P and then are naturally cooled, whereby the ink is promptly in a gel state and solidified (fixed) on the recording medium P.

The fixing unit 25 includes a light emitting unit arranged over the width in the X direction of the conveying unit 21, and irradiates the recording medium P placed on the conveying unit 21 with energy rays such as ultraviolet rays from the light emitting unit, to cure and fix the ink ejected onto the recording medium P. The light emitting unit of the fixing unit 25 is arranged to face the conveying surface 211a in the conveying direction from the arrangement position of the head unit 24 to the arrangement position of the handover drum 281 of the delivery unit 28.

The delivery unit 28 includes the handover drum 281 that has a cylindrical shape and hands over the recording medium P from the conveying unit 21 to a belt loop 282, and the belt loop 282 including a ring-shaped belt whose inner side is supported by two rollers, and the recording medium P handed over from the conveying unit 21 onto the belt loop 282 by the handover drum 281 is conveyed by the belt loop 282, and is sent to the sheet ejection unit 30.

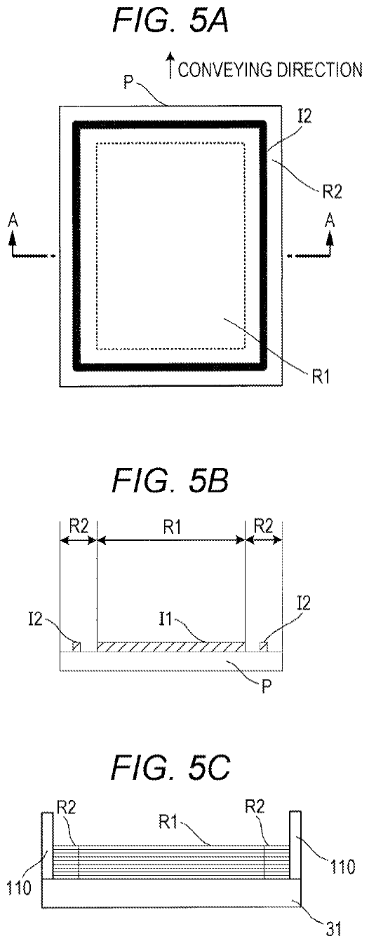

The sheet ejection unit 30 includes a sheet ejection tray 31 that has a plate shape and on which the recording medium P sent from the image former 20 by the delivery unit 28 is placed. In the present embodiment, the recording medium P freely falls one by one onto the sheet ejection tray 31 and sequentially stacked while being abutted against a sheet abutting guide 110 (see FIG. 5C).

FIG. 4 is a block diagram illustrating a main functional configuration of the inkjet image forming apparatus 1. The inkjet image forming apparatus 1 includes the heating unit 23, a head drive unit 241, the image forming head 242, the fixing unit 25, the control unit 40, a conveying drive unit 51, an operation display unit 52, an input/output interface 53, and the like.

The head drive unit 241 supplies a drive signal for causing the piezoelectric element to perform deformation motion depending on image data to the image forming element of the image forming head 242 at an appropriate timing, thereby causing the nozzle 243 of the image forming head 242 to eject ink of an amount corresponding to a pixel value of the image data.

The control unit 40 includes a central processing unit (CPU) 41, random access memory (RAM) 42, read only memory (ROM) 43, and a storage unit 44.

The CPU 41 reads various control programs and setting data stored in the ROM 43 and stores them in the RAM 42, and executes the programs to perform various types of arithmetic processing. Furthermore, the CPU 41 performs integrated control of the overall operation of the inkjet image forming apparatus 1.

The RAM 42 provides a working memory space to the CPU 41 and stores temporary data. The RAM 42 may include a nonvolatile memory.

The ROM 43 stores various control programs executed by the CPU 41, setting data, and the like. Note that, instead of the ROM 43, a rewritable nonvolatile memory may be used, such as an Electrically Erasable Programmable Read Only Memory (EEPROM) or a flash memory.

The storage unit 44 stores a print job (image forming command) input from an external apparatus 2 via the input/output interface 53, image data related to the print job, and the like. Among them, the print job includes information related to the type of the recording medium P on which the image is formed (for example, the size and thickness of the recording medium P), in addition to information designating the image data related to the image to be formed. For example, a Hard Disk Drive (HDD) is used as the storage unit 44, and a Dynamic Random Access Memory (DRAM) or the like may be used in combination.

The conveying drive unit 51 supplies a drive signal to the conveying drum motor of the conveying drum 211 on the basis of a control signal supplied from the control unit 40, to rotate the conveying drum 211 at a predetermined speed and timing.

Furthermore, the conveying drive unit 51 supplies drive signals to motors for operating the medium supply unit 12, the handover unit 22, and the delivery unit 28 on the basis of control signals supplied from the control unit 40, to cause the recording medium P to be supplied to the conveying unit 21, and to be ejected from the conveying unit 21.

The operation display unit 52 includes a display device such as a liquid crystal display or an organic EL display, and input devices such as operation keys and a touch panel arranged to be overlaid on a screen of the display device. The operation display unit 52 displays various types of information on the display device, and converts a user's input operation on the input device into an operation signal and outputs the operation signal to the control unit 40.

The input/output interface 53 mediates transmission and reception of data between the external apparatus 2 and the control unit 40. The input/output interface 53 includes, for example, any one of various serial interfaces and various parallel interfaces or a combination thereof.

The external apparatus 2 is, for example, a personal computer, and supplies a print job, image data, and the like to the control unit 40 via the input/output interface 53.

By the way, in the conventional inkjet image forming apparatus 1, as illustrated in FIGS. 1A and 1B (cross-sectional view taken along a line A-A in FIG. 1A), between an image forming region R1 on the recording medium P and a margin region R2 set outside the image forming region, a minute height difference is generated by the height of ink I fixed to the image forming region R1. That is, the upper surface of the image forming region R1 is higher than the upper surface of the margin region R2 by the height of the ink I.

For that reason, as illustrated in FIG. 1C, when a plurality of the recording media P in which a minute height difference is generated is sequentially stacked one on top of the other on the sheet ejection tray 31, the height differences are accumulated, and the margin region R2 (end side) lower in height than the image forming region R1 hangs down.

As a result, there has been a problem that when the recording media P are stacked one by one on the sheet ejection tray 31 by freely falling while being abutted against the sheet abutting guide 110, slipping or stack collapsing may occur among the recording media P stacked.

Thus, in the present embodiment, as illustrated in FIGS. 5A and 5B (cross-sectional view taken along a line A-A in FIG. 5A), the image former 20 forms a first image I1 (corresponding to image data related to the print job) in the image forming region R1 of the recording medium P, and forms a second image I2 (solid image surrounding the image forming region R1) in the margin region R2 so that the height difference between the image forming region R1 in which the first image I1 is formed and the margin region R2 is reduced.

As a result, it is suppressed that the height difference is generated between the image forming region R1 and the margin region R2 on the recording medium P (see FIG. 5B).

For that reason, as illustrated in FIG. 5C, even when the plurality of recording media P is sequentially stacked on the sheet ejection tray 31, it is suppressed that the margin region R2 (end side) hangs down. As a result, it is possible to suppress that slipping or stack collapsing occurs among the recording media P stacked when the recording media P are stacked one by one on the sheet ejection tray 31 by freely falling while being abutted against the sheet abutting guide 110.

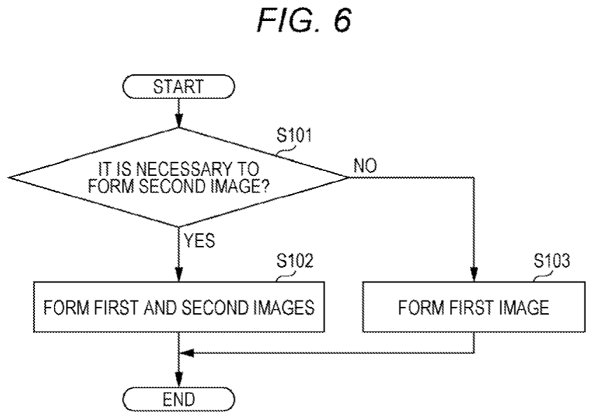

FIG. 6 is a flowchart illustrating an example of image forming processing by the inkjet image forming apparatus 1. The processing of step S101 in FIG. 6 is executed by supplying a print job and image data from the external apparatus 2 to the control unit 40 via the input/output interface 53.

First, the control unit 40 refers to the supplied print job and image data, and determines whether or not it is necessary to form the second image I2 (solid image surrounding the image forming region R1) in the margin region R2 (step S101).

In the present embodiment, the control unit 40 determines whether or not it is necessary to form the second image I2 depending on an end position of the first image I1. For example, when the end position of the first image I1 is located near an edge of the recording medium P, the control unit 40 determines that it is not necessary to form the second image I2 since hanging down of the margin region R2 (end side) is unlikely to occur. On the other hand, when the end position of the first image I1 is not located near the edge of the recording medium P, the control unit 40 determines that it is necessary to form the second image I2 since hanging down of the margin region R2 (end side) may occur.

As a result of the determination, when it is necessary to form the second image I2 in the margin region R2 (step S101, YES), the control unit 40 controls the image former 20 to cause the first image I1 to be formed in the image forming region R1 of the recording medium P, and to cause the second image I2 to be formed in the margin region R2. When the processing of step S102 is completed, the inkjet image forming apparatus 1 ends the processing in FIG. 6.

Note that, in step S102, to cause the user to confirm the second image I2 before the second image I2 is formed in the margin region R2, the control unit 40 may control the operation display unit 52 to cause a preview of the second image I2 to be displayed.

On the other hand, when it is not necessary to form the second image I2 in the margin region R2 (step S101, NO), the control unit 40 controls the image former 20 to cause the first image I1 to be formed in the image forming region R1 of the recording medium P, and not to cause the second image I2 to be formed in the margin region R2. As a result, it is possible to prevent a printing cost increase due to unnecessary formation of the second image I2 even when there is no possibility that hanging down of the margin region R2 (end side) occurs. When the processing of step S103 is completed, the inkjet image forming apparatus 1 ends the processing in FIG. 6.

As described above in detail, the inkjet image forming apparatus 1 according to the present embodiment includes the first image former (image former 20) that forms the first image I1 in the image forming region R1 of the recording medium P, and the second image former (image former 20) that forms the second image I2 in the margin region R2 so that the height difference between the image forming region R1 in which the first image I1 is formed and the margin region R2 is reduced.

According to the present embodiment configured as described above, it is suppressed that the height difference is generated between the image forming region R1 and the margin region R2 on the recording medium P, so that it is suppressed that the margin region R2 (end side) hangs down even when the plurality of recording media P is sequentially stacked on the sheet ejection tray 31. As a result, it is possible to suppress that slipping or stack collapsing occurs among the recording media P stacked when the recording media P are stacked one by one on the sheet ejection tray 31 by freely falling while being abutted against the sheet abutting guide 110.

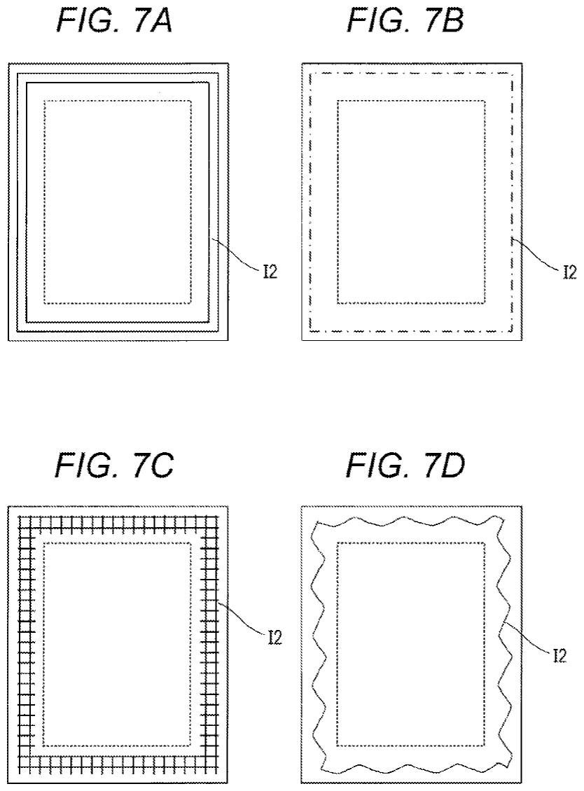

Note that, in the above embodiment, an example has been described in which the second image I2 formed in the margin region R2 is a solid image surrounding the image forming region R1; however, the present invention is not limited to this. For example, a pattern of the second image I2 formed in the margin region R2 may be a double line surrounding the image forming region R1 (see FIG. 7A), a broken line surrounding the image forming region R1 (see FIG. 7B), a lattice surrounding the image forming region R1 (see FIG. 7C), a wavy line surrounding the image forming region R1 (see FIG. 7D), or dots surrounding the image forming region R1. The pattern of the second image I2 can be set arbitrarily if it is the second image I2 with which the height difference between the image forming region R1 and the margin region R2 is reduced and the hanging down of the margin region R2 (end side) does not occur depending on the first image I1 formed in the image forming region R1.

Furthermore, in the above embodiment, an example has been described in which the control unit 40 determines whether or not it is necessary to form the second image I2 depending on the end position of the first image I1; however, the present invention is not limited to this. For example, the control unit 40 may determine whether or not it is necessary to form the second image I2 depending on an area of the margin region R2. In this case, when the area of the margin region R2 is small, the control unit 40 determines that it is not necessary to form the second image I2 since hanging down of the margin region R2 (end side) is unlikely to occur. On the other hand, when the area of the margin region R2 is large, the control unit 40 determines that it is necessary to form the second image I2 since hanging down of the margin region R2 (end side) may occur.

Furthermore, the control unit 40 may determine whether or not it is necessary to form the second image I2 depending on the number of sheets of the recording medium P stacked on the sheet ejection tray 31. In this case, when the number of sheets of the recording medium P stacked is small, the control unit 40 determines that it is not necessary to form the second image I2 since hanging down of the margin region R2 (end side) is unlikely to occur. On the other hand, when the number of sheets of the recording medium P stacked is large (for example, 3000 sheets or more), the control unit 40 determines that it is necessary to form the second image I2 since hanging down of the margin region R2 (end side) may occur.

Furthermore, the control unit 40 may determine whether or not it is necessary to form the second image I2 depending on the rigidity of the recording medium P. In this case, when the rigidity of the recording medium P is high, the control unit 40 determines that it is not necessary to form the second image I2 since hanging down of the margin region R2 (end side) is unlikely to occur. On the other hand, when the rigidity of the recording medium P is low, the control unit 40 determines that it is necessary to form the second image I2 since hanging down of the margin region R2 (end side) may occur.

Furthermore, in the above embodiment, it is desirable that the image former 20 forms the second image I2 so that the distance between the first image I1 and the second image I2 is reduced. This is because, when the distance between the first image I1 and the second image I2 is increased, although slipping or stack collapsing does not occur among the recording media P stacked, adverse effects are likely to occur during cutting and the like since the stacking state degrades.

Furthermore, in the above embodiment, it is desirable that the image former 20 forms the second image I2 in a cutting region in the margin region R2. This is because if the second image I2 is formed in the inner side of the cutting region, the value may be reduced of the recording medium P (commodity) on which the first image I1 is formed.

Furthermore, in the above embodiment, it is desirable that the image former 20 forms the second image I2 in the margin region R2 of the recording medium P corresponding to a page designated by the user. For example, the second image I2 is not formed in the margin region R2 of all pages but is formed in pages at constant intervals, whereby it is possible to suppress generation of slipping or stack collapsing among the recording media P stacked while reducing the ink consumption.

Furthermore, in the above embodiment, it is desirable that the image former 20 forms the second image I2 so that the density difference between the first image I1 and the second image I2 is reduced. This is because, for example, when the first image I1 is formed by using four color inks of yellow (Y), magenta (M), cyan (C), and black (K), and the second image I2 is formed by using one color ink of black (K), the density difference between the first image I1 and the second image I2 is increased, and a height difference is generated between the image forming region R1 and the margin region R2, and the margin region R2 (end side) hangs down.

Furthermore, in the above embodiment, the image former 20 may form the second image I2 in a color designated by the user. As a result, when the ink consumption of the four colors of yellow (Y), magenta (M), cyan (C), and black (K) differs depending on the use state of the inkjet image forming apparatus 1, any ink can be selected to form the second image I2 using the ink with low consumption.

Furthermore, in the above embodiment, the image former 20 may form the second image I2 at a position designated by the user. For example, the image former 20 forms the second image I2 at the position (long side or short side) designated by the user in the margin region R2 of the recording medium P depending on the type of the first image I1.

Furthermore, in the above embodiment, an example has been described in which the recording medium P is conveyed by the conveying drum 211; however, the present invention is not limited to this. For example, the recording medium P may be conveyed by a conveying belt that is supported by two rollers and moves in response to the rotation of the rollers. Furthermore, the recording medium P may be conveyed by a conveying member that reciprocates on the same plane.

Furthermore, in the above embodiment, the single-pass type inkjet image forming apparatus 1 has been described as an example; however, the present invention may be applied to an inkjet image forming apparatus that records an image while performing scanning with the head unit. Furthermore, the present invention may be applied to an inkjet image forming apparatus in which a single nozzle is provided in the head unit.

Furthermore, in the above embodiment, an example has been described in which the first image I1 and the second image I2 are formed by the inkjet method; however, the present invention is not limited to this. For example, the first image I1 and the second image I2 may be formed by an electrophotographic method. In this case, the coloring material used for forming the first image I1 and the second image I2 is toner.

Although embodiments of the present invention have been described and illustrated in detail, the disclosed embodiments are made for purposes of illustration and example only and not limitation. The scope of the present invention should be interpreted by terms of the appended claims That is, the present invention can be implemented in various forms without departing from the gist or main features thereof.

What is claimed is:

1. An image forming apparatus comprising:
a first image former that forms a first image in an image forming region of a recording medium; and
a second image former that forms a second image in a margin region to cause a height difference between the image forming region where the first image is formed and the margin region to be reduced.

2. The image forming apparatus according to claim 1, wherein
the second image former changes whether or not to form the second image depending on an end position of the first image.

3. The image forming apparatus according to claim 1, wherein
the second image former changes whether or not to form the second image depending on an area of the margin region.

4. The image forming apparatus according to claim 1, wherein
the second image former changes whether or not to form the second image depending on a number of sheets stacked of the recording medium.

5. The image forming apparatus according to claim 1, wherein
the second image former changes whether or not to form the second image depending on rigidity of the recording medium.

6. The image forming apparatus according to claim 1, wherein
the second image former forms the second image to cause a distance between the first image and the second image to be reduced.

7. The image forming apparatus according to claim 1, wherein
the second image former forms the second image in a cutting region in the margin region.

8. The image forming apparatus according to claim 1, wherein
the second image former forms the second image in the margin region of the recording medium corresponding to a page designated by a user.

9. The image forming apparatus according to claim 1, wherein
the second image former forms the second image to cause a density difference between the first image and the second image to be reduced.

10. The image forming apparatus according to claim 1, wherein
the second image former forms the second image in a color designated by a user.

11. The image forming apparatus according to claim 1, wherein
the second image former forms the second image at a position designated by a user.

12. The image forming apparatus according to claim 1, wherein
a pattern of the second image is a solid, double line, broken line, lattice, wavy line, or dot pattern.

13. The image forming apparatus according to claim 1, wherein
a coloring material used for forming the first and second images has ultraviolet curability and is cured by being irradiated with ultraviolet rays.

14. An image forming method comprising:
forming a first image in an image forming region of a recording medium; and
forming a second image in a margin region to cause a height difference between the image forming region where the first image is formed and the margin region to be reduced.
